(19) United States
(12) Patent Application Publication
(10) Pub. No.: US 2017/0098335 A1
(43) Pub. Date: Apr. 6, 2017

(54) CARDLESS ACCESS CONTROL WITH ELECTRONIC LOCKS USING SMARTPHONES

(71) Applicant: Stanley Security Solutions, Inc., Indianapolis, IN (US)

(72) Inventor: Walter P. PAYACK, JR., Indianapolis, IN (US)

(21) Appl. No.: 15/284,523

(22) Filed: Oct. 3, 2016

Related U.S. Application Data
(60) Provisional application No. 62/236,344, filed on Oct. 2, 2015.

(51) Int. Cl. G07C 9/00

(52) U.S. Cl. CPC G07C 9/00007; G07C 9/00309; G07C 2009/00769

(57) ABSTRACT

Electronic Locks used for physical access control will be able to wirelessly communicate directly with Smartphones for selectable multi-factor authentication using technology and components built into Smartphones. Systems and methods utilize the phone's digital credential function, the phone's screen unlock keypad function, and the phone's biometric template information and comparison function to establish authentication parameters in order to unlock the door.

This patent application claims priority to U.S. Provisional Patent Application No. 62/236344, filed Oct. 2, 2015, which is hereby incorporated by reference in its entirety.

### FIELD OF THE INVENTION

The present invention relates to access management and control for personal computing devices, such as smartphones. More specifically, the invention is a smart system and methods for granting access to a lock in a number of physical structures. The system and methods are connected to or based on a number of different types of wireless networks for accessing locks using a smartphone.

### BACKGROUND OF THE INVENTION

Smartphones are becoming ubiquitous in our daily lives; we depend on them today, and it is expected that more elements of our daily lives will require a Smartphone in the future. It is foreseeable that your Smartphone will be used as one of a user's main credentials for access control, for all network logging in, for all encrypted messaging, for all payments, office automation, home automation etc.

Access Control is focused on making sure that only designated people have access to certain areas. For many years, mechanical keys were used as single factor access control; but these could be stolen or lent and used by other people. Technology replaced the mechanical key with an electronic card, but it still could be used by unauthorized people to gain access. Keypads were added to the system, prompting the user for a PIN or Passcode in combination with the electronic card.

When using Smartphones for access control, there will be no cards or badges to issue, fewer lost cards or keys to replace as people seldom lose their phones or forget to carry them with them. Stolen or lost phones can be removed quickly and easily from the database, minimizing the opportunity for unauthorized people to gain access.

The current state of art for wireless locks do not utilize selectable multi-factor authentication methods utilizing the smartphone's hardware and infrastructure. There are remote control methods for access management. For example, U.S. Pat. No. 6,675,300 discloses a remote controller that can perform remote control of a personal computer. The remote controller has a unique identifier and the PC to be controlled also has the same identifier stored therein. The remote controller and the computer may communicate by infrared (IR) or radio frequency (RF) signals. The identifier is provided for a security function. The computer checks whether the remote controller's identifier matches its own. If there is a match, the remote controller can be used to issue remote control commands to the computer. Signals from other remote controllers are ignored.

Notwithstanding the usefulness of the above-described methods, a need still exists for to provide smartphone access to locks without access cards and other access control components. Thus, a cardless access control system with electronic locks using a smartphone addressing the aforementioned need is desired.

### SUMMARY OF THE INVENTION

This invention in at least one embodiment includes a method for operating a cardless access control system, the method comprising detecting by at least one smartphone at least one radio corresponding to at least one lock, transmitting a signal to the at least one radio corresponding to the at least one lock, determining by at least one processor authentication of authorized credentials corresponding to the transmitted digital certificate, and determining by the at least one processor access of the at least one smartphone to the at least one lock based on the determined authentication.

In another embodiment, the invention includes a method for operating a cardless access control system, the method comprising detecting by at least one lock at least one radio corresponding to at least one smartphone, transmitting a digital certificate to radio corresponding to the at least one smartphone corresponding to the at least one lock, determining by at least one processor authentication of authorized credentials corresponding to the transmitted digital certificate, and determining by the at least one processor access of the at least one smartphone to the at least one lock based on the determined authentication.

In another embodiment, the invention includes A cardless access control system, comprising a plurality of smartphones, at least one of the plurality of smartphones authorized for access to at least one lock, wherein the at least one smartphone transmits data signals of a plurality of authentication factors, one or more locks, wherein the one or more locks authenticates at least one of the plurality of smartphones for access authorization, at least one digital certificate, wherein the at least one digital certificate is able to be paired with a corresponding lock; and at least one processor, wherein the at least one processor determines whether the smartphone has is authorized to unlock at least one lock.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected” or “attached” includes physical, whether direct or indirect, affixed or adjustably mounted, as for example, the radio is operately connected to the lock. Thus, unless specified, “connected” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying drawings which are provided for illustration purposes as representative of specific exemplary embodiments in which the invention may be practiced. Given the following description of the specification and drawings, the apparatus and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

Given the following enabling description of the drawings, the apparatus should become evident to a person of ordinary skill in the art.

### BRIEF DESCRIPTION OF THE DRAWINGS

FIG. 1 is an environmental view of a door lock and a smartphone, according to the present invention.

FIG. 2 is a block diagram illustrating an embodiment of a general cardless access system using a smartphone to access a lock, according to the present invention.

FIG. 3 is a flowchart of an embodiment illustrating a method for a lock using a smart phone, according to the present invention.

FIG. 4A is an exemplary illustration of recorded phone data of a plurality of unauthorized users according to the present invention.

FIG. 4B is an exemplary illustrations of recorded phone data of a plurality of unauthorized users according to the present invention.

FIG. 5 is a schematic illustration of an embodiment of a method using a smart phone to unlock a look, according to the present invention.

FIG. 6 is a schematic illustration of an embodiment of a method for determining and verifying the smartphone user, according to the present invention.

FIG. 7A is a schematic illustration of a wired network according to the present invention.

FIG. 7B is a schematic illustration of a first wireless network according to the present invention.

FIG. 7C is a schematic illustration of a second wireless network according to the present invention.

Unless otherwise indicated, similar reference characters denote corresponding features consistently throughout the attached drawings.

### DETAILED DESCRIPTION OF THE DRAWINGS

This description is illustrative of the embodiments of the present invention only and not intended to be limiting. The present invention is not limited, however, by the form of wireless signal transmission or any particular communication protocol. The cardless access control using a smartphone can include a system or smartphone connected to a local area network (LAN), a wide area network (WAN), internet, intranet, through Bluetooth ® radio, radio frequency (RF), Bluetooth ® packets, repeaters, etc., and capable of exchanging data with and retrieving data therefrom, for example. To simplify discussion and to allow comparison between figures, like elements are assigned like reference numerals.

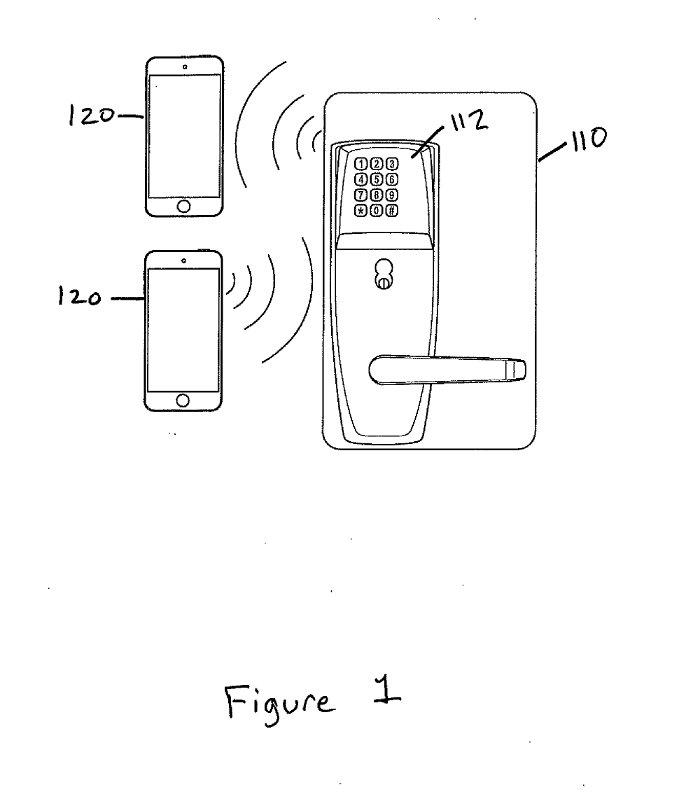

With reference now to the drawings, in particular to FIGS. 1-7C, thereof, systems and methods embodying features, principles, and concepts of various exemplary embodiments of cardless access control with electronic locks using smartphones will be described.

Referring to FIG. 1, there is illustrated an illusory lock 110 with housing containing a keypad 112 for entering in an alphanumeric code, small format interchange core, a reader, an embedded radio for transmitting or receiving signals, and a smartphone 120 for transmitting or receiving signals . The reader is known in the art for access to a lock such as for use with a smart card and will not be discussed. The radio can be a Bluetooth radio, a wireless scanner, a radio frequency identifier (RFID) or a near field communication (NFC) device to detect signals from a mobile device such as a smartphone. It can also include a wireless sensor for detection of a smart phone (not shown in FIG. 1. The lock radio can be in a constant, a substantially constant, a periodic, a random, an on-demand active scanning mode, or can be activated at a designated time, or become activated when the radio receives a signal from a user or a mobile device, such as a smartphone, for example. The sensors can also be in a constant, a substantially constant, a periodic, a random, an on-demand active scanning mode, or can be activated at a designated time, or become activated when the sensor identifies a user or mobile device, such as a smartphone. FIG. 1 illustrates the lock 112 communicating through the embedded radio with the smartphone. The smartphone can be concurrently, intermittently, contemperously, consecutively, sequentially, non-sequentially, or chronologically, transmitting signals with the lock and is not limited in this regard.

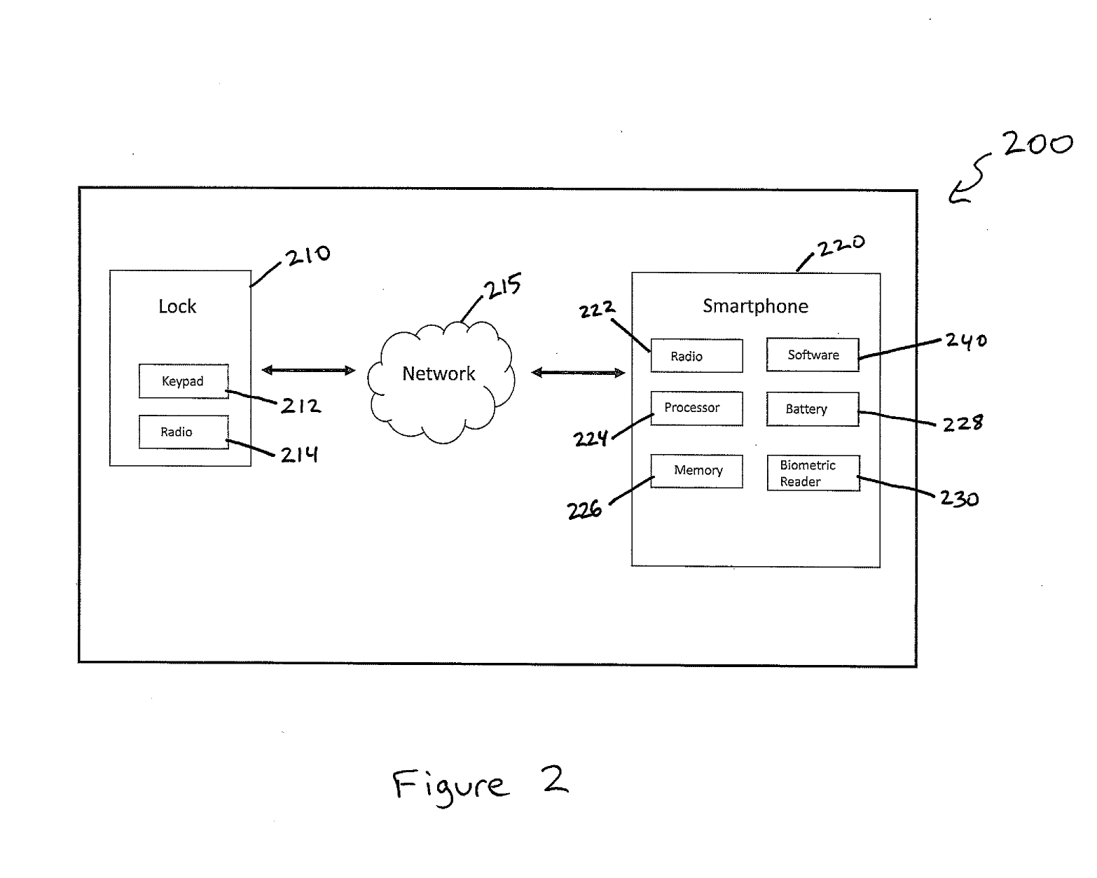

FIG. 2 is a block diagram illustrates an embodiment of a general cardless access environment 200 using a smartphone to access a lock and includes a lock 210, a network 215, and a smartphone 220. The lock includes a keypad 212 that can receive an alphanumeric code and a radio 214. The radio 214 can be a Bluetooth radio, a wireless scanner, a radio frequency identifier (RFID) or a near field communication (NFC) device to detect or transmit signals from or to a mobile device such as a smartphone. The smartphone can include a radio 222, a processor 224, a memory 226, a battery 228, a biometric reader 230, and a software 240. The radio 222 can be a Bluetooth ® radio, a wireless scanner, a radio frequency identifier (RFID), a near field communication (NFC) device, or a cellular antenna to detect or transmit signals.

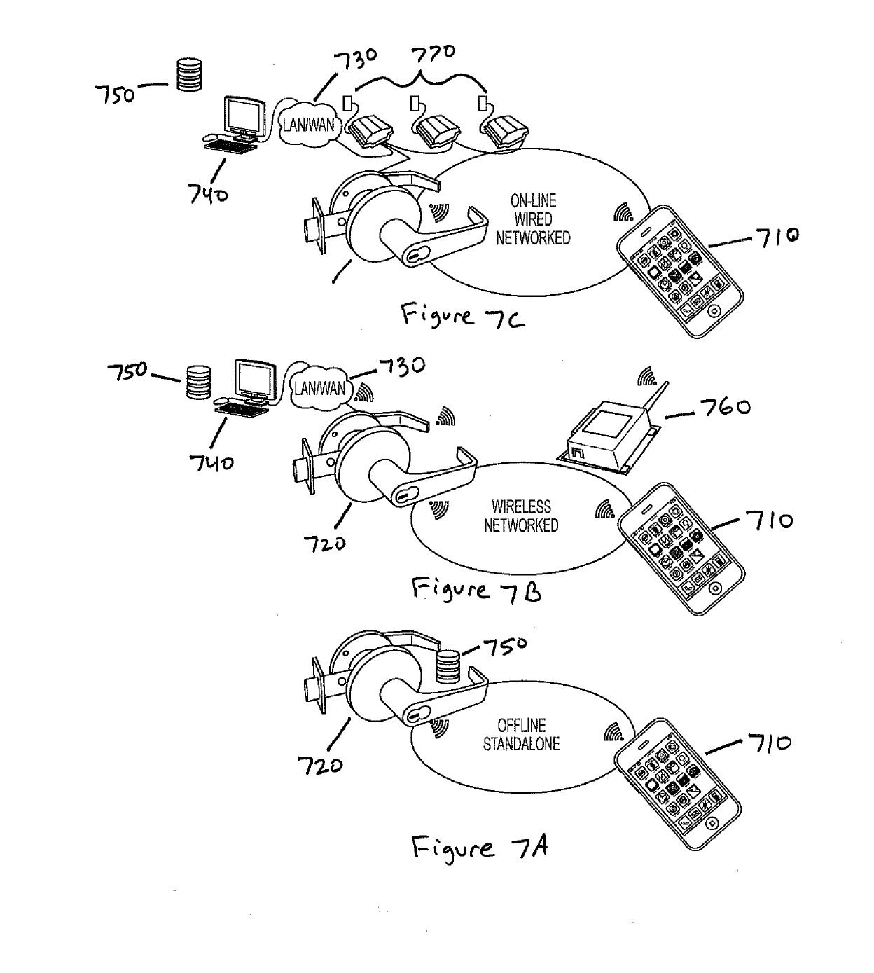

The software 240 can be any type of software suitable for authenticating the smartphone with the lock and is not limited in this regard. For example, in a standalone communication later shown in FIG. 7A, the smartphone can include an application programming interface (API) software designed for traffic management, authorization and access control, monitoring. This is known in the art, available in the public domain, and will not be described here. The software used can be a GUI-based software program that is housed either directly on the smart phone, accessed online through a website, or through a cloud-based system. The software can include a head-end system as known in the art (not shown) that defines access control site and associated parameters. The access control system can be operated in a standalone mode with direct communication between the smartphone and the lock or it can be remotely managed. These will be later illustrated in FIGS. 7A-7C.

The smartphone device 220 can also include other computer-implemented devices, such as mobile computing devices (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, ultrabook™, etc.), e-readers (e.g., Kindle® by Amazon.com®, Nook® by Barnes and Nobles®, etc.), Global Positioning System (GPS)-based navigation systems, etc., and should not be construed in a limiting sense. The memory 226 can be any type of memory and is not limited in this regard. Examples of computer readable memory as can be used or included in the memory 226 can include a tangible, non-transitory computer readable storage medium such as a magnetic recording apparatus, an optical disk, a magneto-optical disk, flash disk, usb drives, and/or a semiconductor memory (for example, RAM, ROM, etc.). The lock 210 can include a memory (not shown) for storing smartphone, access, and traffic data and is not limited in this regard. The lock 210 can include a processor (not shown) for determining smartphone authentication and access and is not limited in this regard.

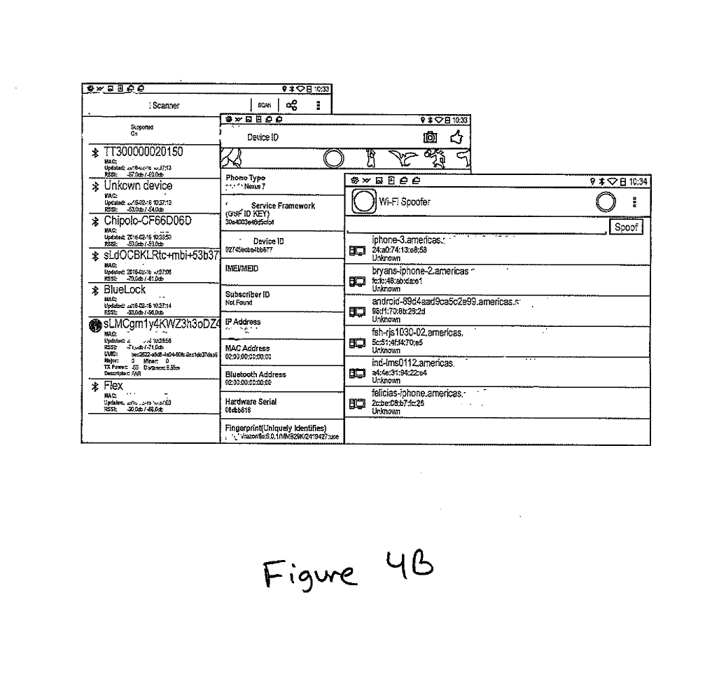

The biometric reader 230 can be any type of sensory input, such as a fingerprint reader, and is not limited in this regard and can also be an voice recognition device, iris scanner, retinal scanner, facial recognition scanner, etc. (not shown). One embodiment of the biometric reader, such as a fingerprint scanner shown in FIG. 5 is known in the art for containing integrated technology that digitally manipulates the digital fingerprint scan via proprietary algorithms that determines based on a binary values for use with a smartphone and will not be discussed. The fingerprint template record can be made available through online systems, wireless networked systems, and cloud systems can access it. The fingerprint template record for standalone embodiments such as shown in FIG. 7A can access fingerprint record data locally from the phone.

The smartphone 220 can be connected to the door lock through a plurality of apparatus (not shown), such as a cellular radio 222a, Wi-Fi radio 222b, NFC radio 222b, Bluetooth radio 222d, or the like to communication with the lock 210. The network 215 can be any type of network, such as network 71. The communication can occur through any type of network, such as a local area network (LAN), a wide area network (WAN), internet, intranet, through Bluetooth ® radio, radio frequency (RF), Bluetooth ® packets, repeaters, etc., capable of exchanging data with and retrieving data therefrom.

The structure shown in FIG. 2 corresponds to access control generally. Access control is generally defined into a number of steps, such as step one having a key (e.g. electronic smart card), a pin code, and a biometric authentication. A user remotely managing access can determine the appropriate level of security based on location and the type of structure a user needs access to. This can vary by lock and location. For example, a university might state that classrooms only need single-factor authentication, e.g. an electronic key such as a smart card typically used in a hotel room. The same university can determine dorm rooms require 2-factor authentication, such as an electronic key and a pin code entered to grant access. Additionally, the university can also determine that research labs require 3-factor authentication, such as an electronic key, a pin code entered, and a biometric authentication of a user to grant access to the structure.

In order to access a lock, the user must first authenticate they have access to the corresponding facility. This access can be determined a number of ways. In the case of using smartphones, a user can initiate an enrollment process, in which the phone can be registered locally or remotely. For local enrollment, the phone, such as the smartphone 220 is brought to the designated registration area (automated kiosk, for example, or even human site operator), where, in close proximity (NFC or BLE), it auto-initiates communication with the head-end registration device. The smartphone 240 and the head end registration device handshake (authentication data transmitted machine to machine) to exchange digital credential information. The credentials and parameters of the smartphone 220 are recorded into the head end system. The head end system can use any type of access and recordation methods to provide authentication such as requiring public key infrastructure (PKI) and issuing certificates for the smartphone 220. The head end system as known in the art can determine the user level, locks the user can access, and facility or zones the user can access. The head end system can be a client-server management system that authentication access based on the proper protocols. In the instance of a remote enrollment, the initiation process is similar, except the first two steps can be the head end system sending an electronic invitation to the smartphone, such as the smartphone 220. The electronic signal can be sent through the network 215. The user can then retrieve the invitation to open an application to begin the handshake authentication between the smartphone and the head end system and then begin enrollment. At the completion of enrollment, the software can send a confirmation to the user through to the GUI and to the smartphone, such as email, text, or other notification (e.g. audible or visual), that the enrollment process is complete.

The structure shown in FIG. 2 can also include the management client-server system 740 as shown in FIG. 7B and can determine what number of factors are needed in the multi-factor authorization based on the type of facility. Additionally, the head end system, such as a management client-server 740 shown in FIG. 7C can transmit a signal to the smartphone 220 to prompt a user to present their enrolled fingers to the biometric reader 230. The head end system (e.g. the management client-server 740) can track user access, facility location and associated parameters and store the data into a database. In an alternate embodiment , the smartphone 220 can timestamp and export the digital representation template of the current fingerprint scan for storage or comparison via a corresponding record in a database or memory, such as the memory 226 either locally or remotely.

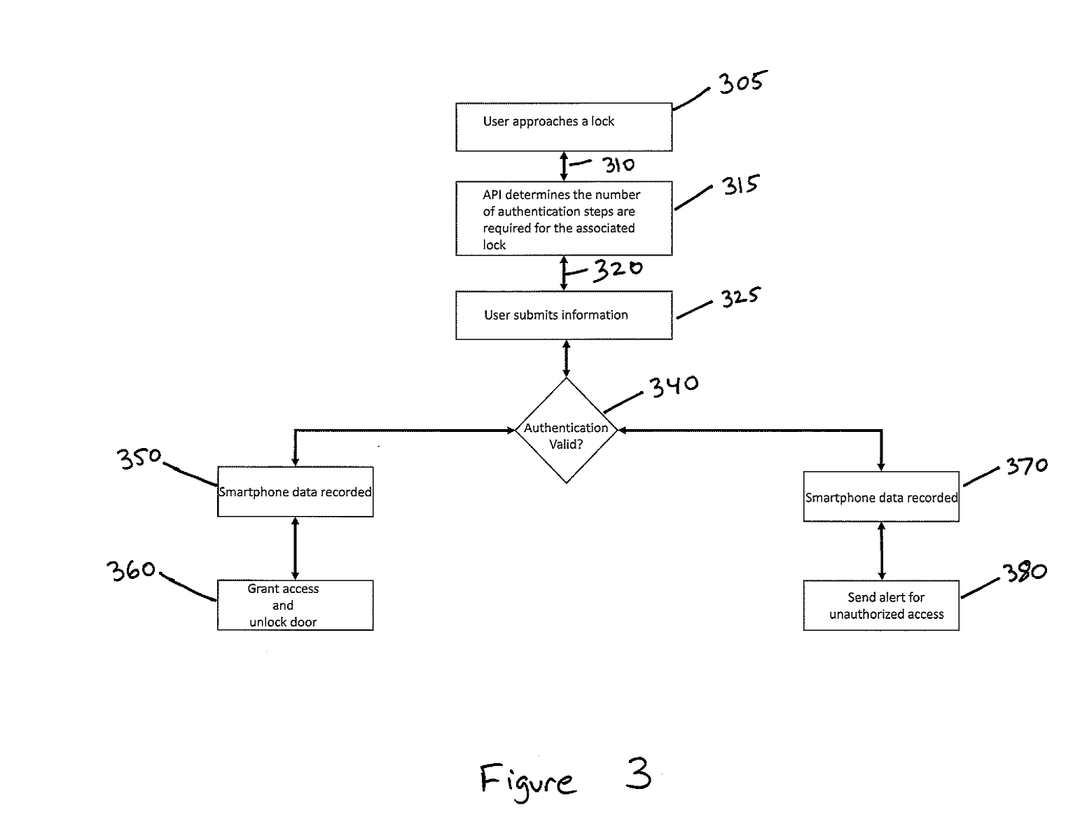

Referring now to FIG. 3, there is illustrated is a flowchart of one embodiment of a method for accessing a lock using a smart phone, according to the present invention. At step 305 the user can approach an associated lock at a predetermined proximity (e.g. NFC or BLE range). At 310 and at the predetermined range the smartphone, such as the smartphone 220 can communicate with the lock, such as the lock 210. At 315, the API such as the software 240 determines the number of authentication factors required for the lock.

At 320, the radios, such as the radio 222 and the radio 214 exchange digital credentials. In at least one embodiment, the software application can automatically pop up, on the screen, such as detection from a NFC tag, indicating initiation of communication. In this step 320, the software 240 can prompt the user to enter in either a number of factors for access, such as using the smartphone 220 as a smart card, or using the smartphone 220 as a smart card and entering in a pin number on the smartphone 220 or in the alternate the software 240 can prompt the user to enter in three authentication factors for access, such as using the smartphone 220 as a smart card, entering in a pin number on the smartphone 220 and confirming user identify on a biometric reader 230. In this embodiment a pin number is used, but the authentication factor is not limited in this regard and another form of pin identification can be used such as a geometric pattern, for example. Furthermore, the authentication factors are listed in one order but are not limited in this regard the authentication required can be a biometric authentication as a sole factor, a pin number as a sole factor, the smartphone as a sole factor any a number of combinations thereof. The type of authentication, number and combinations thereof can be selectively chosen by the user of the smartphone 220, the predetermined by the lock 210, or selectively chosen by a head end system, such as a management client-server system.

At 325, the user can enter the required information and at 340, the software can compare the received digital credentials and user input from the smartphone 220 to the authorized credentials for the associated lock. The authentication comparison is determined based smartphone current credentials against registered credentials either locally direct (NFC/BLE), locally remote (NFC/BLEAA/i-Fi), or even globally (Wi-Fi, Cellular). If the received digital credentials and user input from the smartphone 220 is determined valid, the software 240 records the phone data at 350 and unlocks the lock at 360. At 360 the user can also receive positive confirmation that the use is authenticated, such as shown on the fourth phone image of FIG. 5. If the received digital credentials and user input from the smartphone 220 is determined not to be valid, the radio 214 of the lock 210 transmits the phone data at 370 and sends an alert according the predetermined parameters at 380. In this embodiment of the method for accessing a lock using a smart phone, the smartphone data captured and recorded can be sent back to an authorized smartphone. In alternate embodiments, the smartphone data captured, can be directed sent to an electronic access control system or wait until an authorized smartphone is detected and transmit the captured data.

The alert at 380 can trigger an alarm through the facility, send a notification about an authorized attempt at access to a plurality of users, trigger an alarm, or the lock may go into ScanDown mode as determined by the associated lock or facility. In the instance of a ScanDown mode, the lock will immediately time stamp and go into “scan down” mode, initiating direct communication with any and all nearby Smartphones within range, and capturing future forensic information such as Smartphone registration info, Caller ID info, MAC Address, etc. as examples. In using SWAT school lockdown example of a ScanDown alert, all classroom had been locked down. If any locked is breached, each lock would scan all nearby smartphone for unauthorized access and report back to the head end system the breach alarm. This information can help law-enforcement officials to more accurately see the location of any potential danger such as an active shooter, as well as his phone ID particulars to quickly and positively identify the assailant. This phone data, when paired with GPS can provide real-time location information, even if the event the assailant escapes the scene.

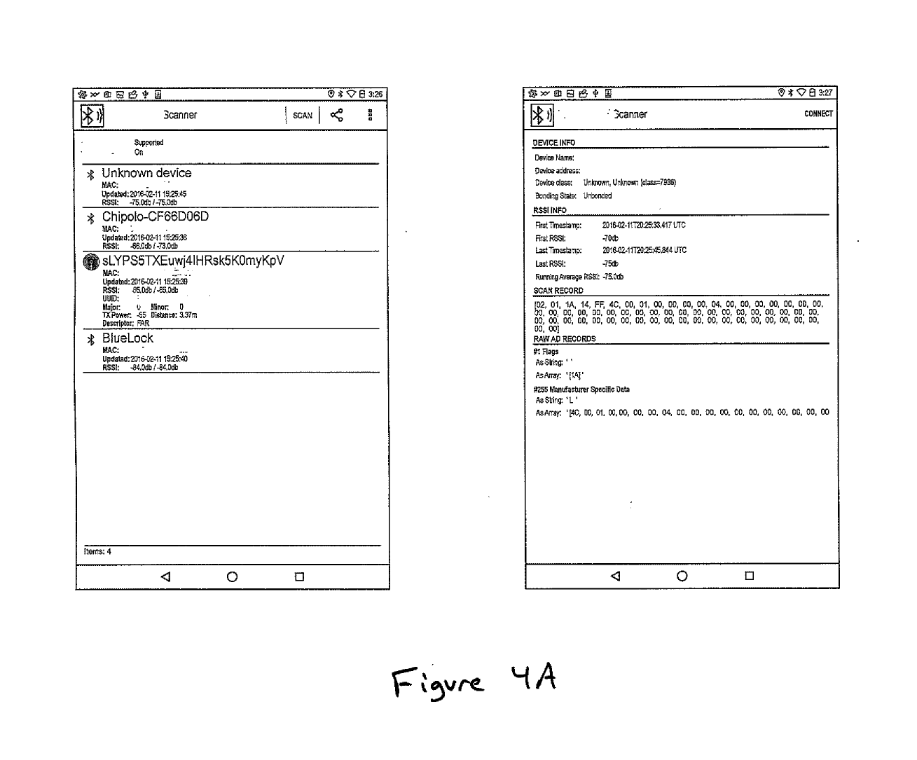

FIG. 4A and 4B are exemplary illustrations of the recorded phone data of unauthorized users according to the present invention. As described at 370 of FIG. 3, the radio sends phone data and sends an alert according the predetermined parameters. The alert can trigger an alarm through the facility, send a notification about an authorized attempt at access to a plurality of users, trigger an alarm, or the lock may go into ScanDown mode as determined by the associated lock or facility. In FIG. 4A and 4B is illustrated the type of notification sent to any and all nearby Smartphones within range or a management system and capturing future forensic information such as Smartphone registration info, Caller ID info, MAC Address, etc. as examples.

FIG. 5 illustrates one embodiment of a method using a smart phone to unlock a look. This embodiment can be executed according to the multi-step authentication such as requiring phone access, pin number authentication, the phone shown at 510 illustrates a standard smartphone. Continuing from 515 to step 520 the user can enter a pin number to unlock their phone. From 525 to step 530 the user places a finger at a biometric reader, such as the biometric reader 230. From 535, the smartphone can communicate through its radio, such as the radio 222, to the radio 210 in the lock.

The authentication process can be done by the smartphone 220 sending a unique key through its radio 222 to the radio 214 of the lock 210. The lock can return an echo back through its radio 214 to the radio 222 of the smartphone 220 to pair the devices. The lock radio 222 can be in a constant, a substantially constant, a periodic, a random, an on-demand active scanning mode, or can be activated at a designated time, or become activated when the radio receives a signal from a user or a mobile device, such as a smartphone, for example. Other forms of pairing can be done, such as Bluetooth ® packets, and is not limited to the standard Bluetooth ® pairing. Additionally, other forms of authentication can be done and is not limited to the public key infrastructure handshake authentication. Upon authentication, the radios transmit authorization and the smartphone 220 receives authentication at step 540 and the lock 210 becomes accessible to the user.

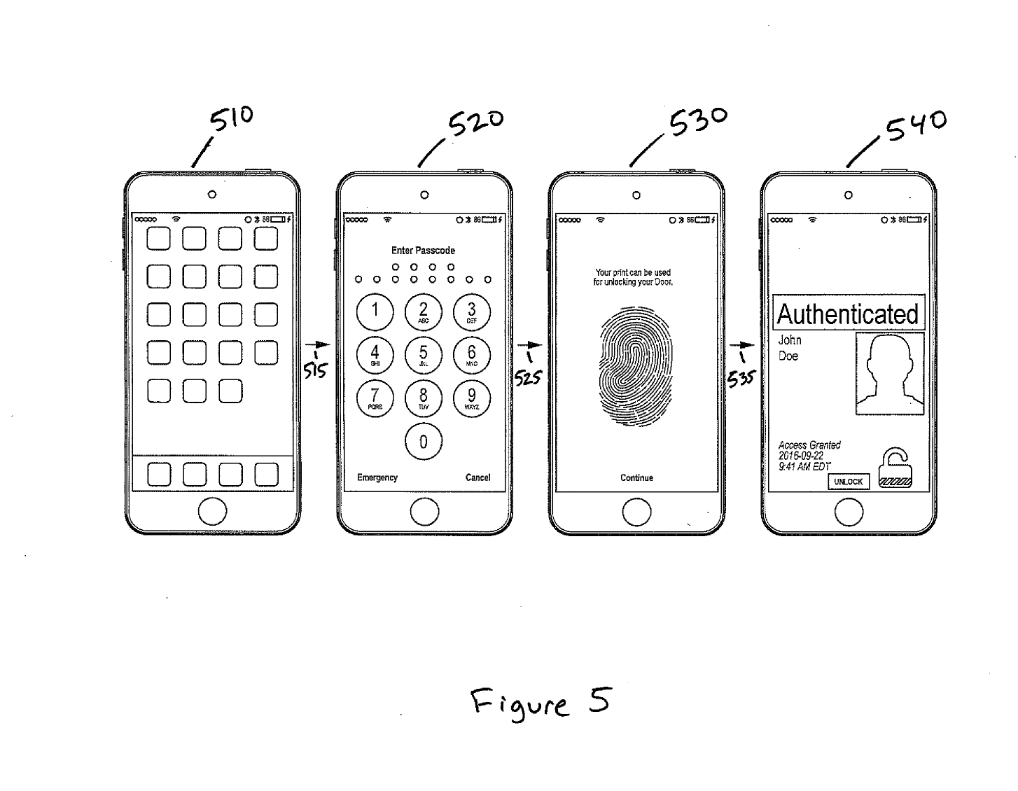

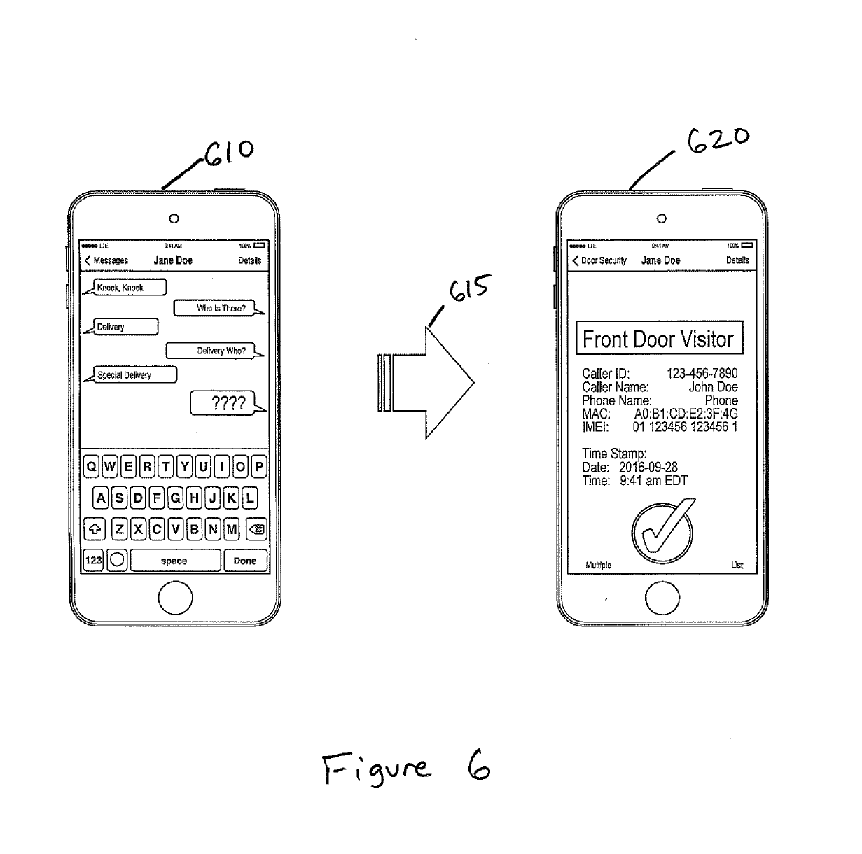

FIG. 6 illustrates an embodiment of a method for determining and verifying the smartphone user, according to the remote access system. For example, at 610 a user can send a text to another user or to a remote system. At 615, the user or the remote system can authenticate the smartphone based on its credentials, such as a public key infrastructure (PKI) to identify or determine whether to provide access. Step 620 illustrates a user or the remote system identifying the visitor and provides details relating to the phone number, the associated name with the number, the smartphone's mac address, IP address, phone identification number, and provides a time stamp. The captured inform can be completed by an automated scripted process that takes surface parameter info, e.g. the information provided at 620, to read and record such device specific information and store it into a database or memory, such as the memory 226.

Referring now to FIG. 7A, there is illustrated a block diagram illustrating a general cardless access control environment 200 that can be utilized to implement embodiments of systems and methods for cardless access control with electronic locks using smartphones. The cardless access control environment 200 in FIG. 7A further illustrates a system environment that includes a smartphone 710, a lock 720 and a database 750. The memory in the smart phone can be the database in this embodiment. The smartphone 710 and the lock 720 are exemplary and can be the smartphone 220 and the lock 210 shown in FIG. 2.

FIG. 7B also illustrates a block diagram illustrating a general cardless access control environment 200 that can be utilized to implement embodiments of systems and methods for cardless access control with electronic locks using smartphones. The cardless access control environment 200 in FIG. 7A further illustrates a system environment that includes the smartphone 710, the lock 720, a network 730, a management client-server 740, a database 750, and a repeater 760. The network 730 is illusory and can be the network as shown in FIG. 2. Although this embodiment illustrates a wireless network, the network 730 is not limited in this regard and can be any type of network, such as a local area network (LAN), a wide area network (WAN), internet, intranet, through Bluetooth ® radio, radio frequency (RF), Bluetooth ® packets, repeaters, etc., capable of exchanging data with and retrieving data therefrom, for example. The management client-server 740 can be various hardware (e.g. client and servers such as the head end system described above) and/or software (e.g., threads, processes, computing devices), and should not be construed in a limiting sense.

FIG. 7C also illustrates a block diagram illustrating a general cardless access control environment 200 that can be utilized to implement embodiments of systems and methods for cardless access control with electronic locks using smartphones. The cardless access control environment 200 in FIG. 7A further illustrates a system environment that includes the smartphone 710, the lock 720, a network 730, a management client-server 740, a database 750, and a wired network 770.

In this embodiment, the lock 720 communicates through the wired network to communicate with the main network 730. Although this embodiment illustrates a wired network, the network 730 is not limited in this regard and can be any type of network, such as a local area network (LAN), a wide area network (WAN), internet, intranet, through Bluetooth radio, radio frequency (RF), Bluetooth ® packets, repeaters, etc., capable of exchanging data with and retrieving data therefrom, for example.

In one embodiment of the standalone communication of FIG. 7A between the smartphone 220 and the lock 214, each time the smartphone 220 is presented to the lock 210, it establishes credentials and authentication and simultaneously uploads from the lock 210 the audit trail records and potential maintenance issues, such as low battery to the smartphone 220. As the user wanders around, the smartphone can come in range or proximity to an network connected device or system to transmit and offload the standalone lock's audit trail and maintenance info (byes and kilobytes) such that this info can be merged into a head-end system master log without specific physical actions to collect it. This can also be done through the smartphone 220 system that is connected to the network.

In at least on embodiment of the present invention, there is a speed feature for allowing quick access. For example, in the lock 210 requires a multi-factor authentication, such as using the smartphone 214 as a smart card and providing a biometric authentication, the speed feature allows the two authentication factors to be done simultaneously. The user can waive the smartphone 214 as the smart card near the lock 210 while concurrently placing a finger on the biometric reader 230.

This speed feature can also be used in a number of settings or modes such as a maintenance mode. For example during annual battery change out, that registered maintenance personnel phones only require single factor to facilitate fast efficient door-to-door action; again audit trail time stamps all access openings. SWAT mode might be similar in that the site executive (or other registered designated Smartphone) could go door-to-door with the SWAT team and open each classroom door with single factor authentication.

In an alternate embodiment of a speed feature using digital credential authentication between the smartphone 220 and the lock 210, the predetermined authentication can also include another speed feature that automatically recognizes the user based on the digital credentials. In this embodiment of the speed feature, the smartphone 220 is constantly linked to an electronic access control system, such as the management client-server 740 and automatically provides access based on the credentials associated with the smartphone without the user having to provide additional authentication.

The present invention relates to access control management for computing devices such as a smartphone device. It can also use a key fob or another type of mobile device. It takes a new, convenient and secure approach to allowing access to a lock, such as a door lock, without requiring the convention key or smartcard. Only when a wireless identifier key, such as a public key identifier (PKI), carried by the authorized user on a smartphone is brought into the space of the door, the look will unlock and allows access to this user.

The information and operations that are transmitted throughout the various embodiments of systems and the methods for cardless access control with electronic locks using smartphones can be in the form of electronic data, wireless signals, or a variation thereof, for example. The information and operations that are transmitted throughout the various embodiments can be sent wirelessly, optically, or by various types or arrangements of hard wire connections, or combinations thereof, among the various system components, for example.

Embodiments of systems and the methods for cardless access control with electronic locks using smartphones also include for the processor 224 to transmit phone data regarding whether at least one smartphone is authorized as can be displayed on a display associated with a systems associated with cardless access control with electronic locks using smartphones, such as electronic or digital message boards, or on a computer display, which are capable of displaying information

The example and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein. It is to be understood that the present invention is not limited to the embodiments described above, but encompasses any and all embodiments within the scope of the following claims.

We claim:

1. A method for operating a cardless access control system, the method comprising:
detecting by at least one smartphone at least one radio corresponding to at least one lock;
transmitting a signal to the at least one radio corresponding to the at least one lock;
determining by at least one processor authentication of authorized credentials corresponding to the transmitted digital certificate; and
determining by the at least one processor access of the at least one smartphone to the at least one lock based on the determined authentication.

2. The method of claim 1, further comprising scanning by at least one radio for a predetermined period.

3. The method of claim 1, further comprising transmitting wireless signals by at least one radio of at least one digital certificate.

4. The method of claim 1, further comprising determining by the at least one processor the number of authorized smartphones accessed at least one lock.

5. The method of claim 1, further comprising, transmitting by the at least one processor notification of a plurality of determined unauthorized credentials.

6. The method of claim 1, further comprising recording by a memory, the plurality of unauthorized credentials.

7. The method of claim 6, further comprising recording by the memory a plurality of identification data of a plurality of smartphones corresponding to the plurality of unauthorized credentials.

8. A method for operating a cardless access control system, the method comprising:
detecting by at least one lock at least one radio corresponding to at least one smartphone;
transmitting a digital certificate to radio corresponding to the at least one smartphone corresponding to the at least one lock;
determining by at least one processor authentication of authorized credentials corresponding to the transmitted digital certificate; and
determining by the at least one processor access of the at least one smartphone to the at least one lock based on the determined authentication.

9. The method of claim 8, further comprising scanning by at least one radio for a predetermined period.

10. The method of claim 8, further comprising transmitting wireless signals by at least one radio of at least one digital certificate.

11. The method of claim 8, further comprising determining by the at least one processor the number of authorized smartphones accessed at least one lock.

12. The method of claim 8, further comprising, transmitting by the at least one processor notification of a plurality of determined unauthorized credentials.

13. The method of claim 8, further comprising recording by a memory, the plurality of unauthorized credentials.

14. The method of claim 13, further comprising recording by the memory a plurality of identification data of a plurality of smartphones corresponding to the plurality of unauthorized credentials.

15. A cardless access control system, comprising:
a plurality of smartphones, at least one of the plurality of smartphones authorized for access to at least one lock, wherein the at least one smartphone transmits data signals of a plurality of authentication factors;
one or more locks, wherein the one or more locks authenticates at least one of the plurality of smartphones for access authorization;
at least one digital certificate, wherein the at least one digital certificate is able to be paired with a corresponding lock; and
at least one processor, wherein the at least one processor determines whether the smartphone has is authorized to unlock at least one lock;

16. The cardless access control system of claim 15, wherein the at least one processor is associated with at least one lock.

17. The cardless access control system of claim 15, wherein the at least one processor is associated with at least one smartphone.

18. The cardless access control system of claim 15, wherein the at least one smartphone further comprises a biometric reader.

19. The cardless access control system of claim 15, further comprising at least one radio, wherein the at least one radio transmits wireless signals corresponding to at least one digital certificate.

20. The cardless access control system of claim 15, further comprising the at least one processor concurrently receiving a plurality of authentications corresponding to at least one smartphone.
